(19) United States
(12) Patent Application Publication
(10) Pub. No.: US 2023/0296361 A1
(43) Pub. Date: Sep. 21, 2023

(54) SYSTEM AND METHOD FOR END TO END TRANSPORT DELIVERY

(71) Applicants: Hazim Mohaisen, Redmond, WA (US); Khaled Ahmed Essam Abdel-Rahman, Bellevue, WA (US)

(72) Inventors: Hazim Mohaisen, Redmond, WA (US); Khaled Ahmed Essam Abdel-Rahman, Bellevue, WA (US)

(21) Appl. No.: 17/700,260

(22) Filed: Mar. 21, 2022

(51) Int. Cl. F42B 12/56; B64C 39/02

(52) U.S. Cl. CPC F42B 12/56; B64C 39/02; B64C 2201/128

(57) ABSTRACT

The present invention pertains to a system and method for transportation of goods, service, marketable securities or other valuable payloads optionally utilizing a carrier or smart carrier to contain a payload and using artillery for transporting the payload relatively longer distances, whereby more conventional transportation systems may bring a payload to the artillery mechanism and then retrieve the payload from the artillery mechanism. The system consists of a modified military artillery projectile, optionally containing a self-monitoring smart carrier or a standard carrier, transportation shells for various transportation methods and when smart carriers are employed, goods and services and in some embodiments, people, on land, air and water through a connected ecosystem, may be monitored and safely transported. Modified military artillery is used to propel goods to discrete distance remote stations, alongside, in some examples, torpedoes, sniper rifles, and other long rage apparatuses, such as drones, mortars, and howitzers. The selection of what artillery to use is a function of availability and desired distance and performance, and the interaction with non-ballistic delivery systems, to and from the artillery or ballistic legs of the desired delivery pathway, are ones of optimal design and performance choice of a user of the present invention.

### BACKGROUND OF THE INVENTION

The present invention relates to a ballistic, point to point transportation mechanism and system comprised of processing, inspection and transportation stations for delivery and preparation of various goods. The system maintains several methods that are existing elements of the current marketplace, as well as novel features. Present transportation systems rely heavily on distribution centers, cars, trucks and planes, and in turn, an array of other factors, such as the glacial pace of long-distance delivery with limited capabilities. Other issues associated with the prior art include immense environmental impacts in contemporary transportation methodologies which produce significant carbon emissions, and even sound pollution which disrupt ecosystems. More recently, drones have been utilized for efficient point to point delivery systems but are often limited in terms of the distance required for delivery and desired speed for desired delivery requirements. Indeed, in remote regions of the world, there exists a need for delivery on a same day or overnight basis, between points separated by several hundred miles.

Congested highways and waterways, delayed deliveries, and investments on expensive road infrastructure have all proven to be costly and inefficient as mediums of transportation. The present invention seeks to remedy the problems associated with end-to-end delivery, among other issues. Because these deliveries are often road bound, there are obstacles such as speed limits, closures and accidents that interfere with the urgency of certain deliveries. A federal study concluded that road damage from an 18-wheeler vehicle is equivalent to the impact of 9,600 cars and causes more wear and tear than tractor trailers. Trucks with heavier loads damage state and local roads that are not built with the impact of their weight in mind, as this model generates traffic on non-arterial rural roads by 16%. In that same study, approximately 22% of all loaded tractor-trailers exceed state weight limits, and the percentage only rises for other types of trucks. Federal weight limits are often combative against state regulations, which adds to the cumbersome organizational structure of the delivery method. In other words, there exists a need to send materials from point to point without reliance on a pre-constructed way of passage, such as roads, tunnels, bridges and the like.

Last mile deliveries, which feature the movement of goods through traditional travel methods, have continued to create logistical complications. The present invention seeks to remedy these issues with the novel approach of discharging goods or services or a combination thereof to people door to door, with the use of projectile artillery, modified transportation shelling, torpedoes, and fitting shells that employ scramjet and ramjet design technology.

In addition, the prior art is often categorized by mode of transportation: drones are drones for relatively short range air; helicopters are helicopters; cars are cars for roadways, etc. Intermodal systems do exist (train or rail to plane; maritime shipping containers to air or land or rail; trucks to air, etc.), but, so far, no intermodal transportation or delivery system has been taught whereby ballistic (using a missile projectile) point to point transit is provided with a smooth hand-off from and to localized transportation, such as to a drone or hand delivery mechanism or land or sea based autonomous vehicle system. In other words, often, the inefficiency of the originating transportation mode (e.g., land courier) is inefficiently adopted to the end destination, resulting in roadway congestion and other undesired effects and delivery chaos. The prior art does have some suggestion of the use of drones for point to point delivery, but the present invention uses a ballistic missile to cover various desired distances, and to seamlessly interface with both supplying the ballistic transport and off-loading the ballistic transport, so that the ballistic segment is used in optimal proximity with other modes of transport to and from the ballistic link. Moreover, nowhere in the prior art has such an arrangement been taught in connection with a carrier or smart carrier, which encapsulates the payload of interest, which can be virtually any type of payload, from valuable to toxic or dangerous, to precious or non-fungible, to invaluable. In all cases, the user of the present invention would want to track the payload, insure that the payload is not compromised (over shock, out of temperature ranges, tampered with during the transport, and so forth), so that a safe and efficient and timely delivery of a payload is insured. There exists a need as well for supervised delivery systems that incorporate a ballistic missile projectile in at least one leg of the overall system, whereby valuable payloads (including cash) may be transported from a sender to an intended recipient, in a manner where the payload is encapsulated within a missile for example, or alternatively, encapsulated within a carrier or smart carrier within a missile for at least part of the transportation journey, to improve delivery times and overall efficiency and payload integrity and security.

### SUMMARY OF THE INVENTION

The present invention relates to a mechanized system for delivery, preparation and the transportation of goods, services and people to various locations using at least one artillery or ballistic projectile link or missile in the delivery process. There are several examples of this mechanized system in use, and they require modifications to traditional military grade equipment in order to optimize the process in order to ensure both safety and promptness. In one example, preparation and delivery of goods and services can be organized from a hospital, pharmacies, lab, or any central supply locality to other locations, such as specific units in the hospital, and even residential neighborhoods. The process utilizes several steps, such as, the preparation of goods, the ways in which goods are assembled, optionally through automated means, which utilize robot devices that carry and transport, for example, carriers or smart carriers within a facility setting or manned means, wherein loading is executed by an individual tending to each launch station and then discharged. Smart carriers (or carriers in general) for containing payloads of interest come in an extensive variety of shapes and sizes in order to accommodate the physical characteristics of the system in use. They are used to transport a multitude of articles, by way of example and not by way of limitation, such as cash, electronic data, medical samples, pharmaceutical supplies, stock transactions, letters, and cryptographic materials. These carriers, which can be situated in a broad range of caverns in a cylindrically compatible missile, which upon modification, creates a cavernous location to store the goods. In order for these carriers to fix themselves within their transportation encasements, they must be closed and sealed entirely. To affirm, each of these carriers are to be fashioned with security measures, by way of example and not by way of limitation, lock or pass codes, QR codes, cryptographic codes, decryption requirements, facial recognition software, or other locking mechanisms that are only active upon specified authorized parties retrieving their item. The carriers are particularly important to the present invention, in that the carrier may have its own telemetry port for providing status and control to the outside world. For example, if the payload within a carrier is particularly valuable, the carrier should employ security measures or alarms or silent alarms. Also, if a point of sale payment system is combined with the present invention, the carrier needs to be capable of reading and transmitting its environment, including by imaging, sound gathering and the like. In other words, the smart carrier according to the present invention may be brought to a ballistic missile launch pad by a robot or drone; “launched” via a ballistic missile many miles away; received at a ballistic missile receiving pad; and then loaded to a local delivery service (courier, human, drone, etc.). But, at each point, the carrier may record and store where it has been, temperature, security parameters, access attempts, and any volume of information to insure that the payload has been safe, not tampered with, if toxic contained safely without detectable leakage, and be able to keep the payload safe, isolated and secure, so that point to point payload integrity is insured, by way of a smart carrier and its carriage upon a ballistic missile during the desired point to point transfer.

These systems and methods consist of several steps, which involve queuing and inputting and requesting good and service on to some type of app or communication device, such as a mobile device, preparing the product, inspecting the product, loading the product, and then a final transportation step, which involves launching the carrier with the product for delivery. The invention utilizes a robotics handler for handling carrier as desired, for insertion into a missile or receipt from a missile, interfacing with other modes of transportation. The overall transportation system according to the present invention must transport carrier payloads with the utmost safety, use of projectile technology, and security measures to ensure the safe departure and arrival of goods and services. In places such as hospitals, certain necessities need to be prepared habitually. An automated system in conjunction with the mechanized system will aid in the simplification of manual operations, all while maintaining speed and efficiency.

The present invention also bypasses the issue of congested roads and speed limits by avoiding them entirely, all while using military grade artillery and modifications to transportation shells and delivery drones, in an effort to ameliorate the process and transportation standards. These systems and methods also cause significantly less environmental damage that is caused by carbon emissions from trucks, which may also run into the issue of overwhelming infrastructure due to weight restrictions. In remote regions of the world, through the use of the present invention, many hundreds of miles, for example, may be traversed without the need for scheduled air service or even the use of an airport. Instead, a drone can take a carrier or smart carrier from a sender (the carrier contains the payload of interest), and then the payload within the carrier (and if a smart carrier, the payload is monitored at all times (open/close, shock, vibration, temperature range, audio transcript, video surveillance, point of sale data, etc.) and able to provide GPS data as to position autonomously, and able to communicate with all the associated handling systems according to the present invention), and deliver the payload to a receiver desired by the sender, whereby the carrier containing the payload may be handled any number of times. By way of example, the payload and carrier may be inserted into a carrier holder of a drone, passed off to a ballistic shell to contain the carrier and then handed off to other missiles or projectiles or drones, until the ultimate destination is reached. The recipient of the payload not only receives the payload but receives tracking data as to the position and environment of the payload, to insure its quality and integrity upon receipt.

Furthermore, deliveries that are both prompt and reliable (e.g., safe) are essential to the daily operations of multiple facilities, with a hospital or medical environment being exemplary. Traditional delivery methods, such as cars, trucks, and planes are becoming outmoded due to their negative environmental impacts, such as pollution, that overwhelm the atmosphere with emissions. The present invention seeks to transfigure the process by producing both a speedier, and more streamlined system with the use of carriers or smart carriers, and modified transportation shells for projectile deliveries, and in some embodiments, torpedoes. The present invention is an ecosystem for an end-to-end transport that delivers various goods door to door. These systems and methods account for optimizing the transportation industry. The primary fixture for this ecosystem implements projectile artillery, such as large range military artillery, mortars, howitzers and torpedo units that yield carriers and containments for goods.

The system comprises various encasements dependent on the type of transportation artillery used. In one embodiment, the method of transportation is a modified 155 mm shell. The modified transportation shell, which can vary in size, can be acted upon by a pusher plate, and an electronic time sensor. The transportation shell or carrier is then fixed on to a moveable apparatus and a projectile cannon thereafter. The cannon is, in essence, any large tubular firearm that has the ability to launch projectiles over a large distance, with the added modification of using reinforced material that has a greater ability to withstand supersonic velocity and an extended shell range. The way in which a shell range can be extended is by increasing the muzzle velocity, which results in the projectile coming out of the apparatus faster, and therefore farther before drag and gravity brings it down. Another way in which the range can be modified is by adding lift surfaces, such as wings and fins to the shell for a more aerodynamic model. With more lift generated, the projectile can fly for even longer. Lastly, adding a post launch propulsion, or a ramjet, can greatly help in thrusting the projectile. Shock absorbing material is also an essential component in protecting the product and is a crucial implementation in ensuring safety. These modifications all allow the ballistic projectile apparatus to withstand more. In addition, any carrier or smart carrier contained within an artillery shell according to the present invention may possess its own shock sensor, so that the condition of the payload may be monitored at all times.

The present invention relates to a mechanized system for delivery, preparation and the transportation of goods, services and people to various locations using military artillery. The mechanisms include an ecosystem for an end-to-end transport that delivers various goods and services door to door. These system and methods account for optimizing the transportation industry. The primary fixture for this ecosystem implements projectile artillery, such as large range military artillery, mortars, howitzers and torpedo units that yield carriers or smart carriers and containments for goods and services.

The system comprises an input queue, a dispensing figure and apparatus consisting of a robotic device, a plurality of separate stations in which the robotic device executes its mechanisms, an inspection station, and a loading station. The plurality of stations aids in the transportation of goods and services. A digital, or computer interface enables bi-directional communication between the analytical instruments of the operation, computers, robots, and the subsequent peripheral devices. The robotic and automated functions are responsive to predefined computer demands and are capable of performing functions, such as selection and retrieval in order to obtain what is contained for departure. The contents of the carrier or smart vary depending on the industry, distributor or manufacturer, associated of course with the user of the transportation system according to the present invention. Different information may also be required and disclosed, such as name, item characteristics, precise location, label instruction and notes, among other things, which are dependent on the industry, distributor or manufacturer.

Barcodes, QR codes, and or blockchain technology could be used to provide any of the above-mentioned information upon scanning, or retrieval, therefore enabling the control system database to be scoured to determine the status of any product at any time during both preparation and transportation. Furthermore, the system may enable manual requests, which allows cleared people to input this data at any plurality of computer terminals within a hospital, institution, warehouse, business, etc.

In accordance with the preferred embodiment of the present invention, the cylindrical shells, or transportation shells, which may be a modified shell of varying size, contains a Discarding Rotating Band (DRB), a base plug, a carrier transportation, a pusher plate, and an electronic time sensor. The transportation shell or carrier is then fixed on to a moveable apparatus and a projectile cannon thereafter for the delivery process. The cannon is a tubular firearm that has the ability to launch projectiles over a large distance, with added modifications to further ruggedize the technology, in order for it to withstand supersonic velocity. The transportation shell or carrier employs ramjet technology to extend their range by way of increasing muzzle velocity, adding lift surfaces such as wings and fins to the shell for a more aerodynamic effect, and by adding the ramjet, which is a post launch propulsion that can help trust the projectile. The projectiles also have shock absorbing material in order to ensure strength and safety throughout the journey to its destination. The above technology will allow for the transportation of goods, up to 50 kilograms, over 100 kilometers expeditiously, and in various types of cannons, which could discharge goods to distances up to 1000 miles, when factors such as projectile weight, length, velocity, pressure, charge and propellant type and weight are taken into consideration.

In one embodiment, a 138 mm bullet casing can be used to transport highly secure messages. With decryption becoming more viable, a higher rate of encryption can be achieved with the present technology's system and methods. In one example, a USB thumb drive with data can be encased within a stationed sniper rifles .50 caliber bullet, which are traditionally 138 mm and 5.45 inches in length. In another, cryptographic materials may be stored within the bullet's casing, in an effort to maintain maximum security.

The architecture of the invention also considers a distance between two drop off stations, with the assistance of drone technology to manage the transport in one embodiment. The distance between these stations may be 50 kilometers to 100 kilometers. At each station, the transportation shell, which transports a carrier, is loaded into a cannon or any ballistic projectile apparatus and subsequently launched to several stations until it is in proximity to the final destination.

In another embodiment, the present invention utilizes torpedoes in order to transfer and move goods throughout bodies of water. In some examples, there can be human torpedo transportation. In others, there are transportation torpedoes that discharge goods through various ports and stations in bodies of water. The shell or cannister in this example utilizes a cavitating appendage, which ejects gas throughout the torpedo's nose. In the same embodiment, there are detection and homing electronics to ensure that the torpedo remains on target. The invention utilizes a cavity piercing control fin in order to steer the missile and a storage tank for bubble-generating gas. The rocket motor of the torpedo allows it to accelerate up to 230 miles per hour, ensuring the quick transport of goods.

In another example, the transportation shell or carrier is modified to convert into a drone with expandable rotors that push the air down for propulsion and control. The modified rotors allow the shell to deploy in midair, emulating a drone landing. These modifications allow the transported goods to enable extended flights and withstand significantly heavier loads. These drone devices meet at various stations that are multiple kilometers in distance, which are then subject to movement to other destinations, depending on the variable of stations present. These goods can then be transported to, in some examples, a residential area.

In yet another embodiment, the casing may be housed within other forms of military grade equipment, such as military tanks, mortars, howitzers and other robust artillery. The container can be safely projected up to 40 km using new and improved launch technology, such as modified transportation shells—and in some examples be reused once emptied. Accordingly, it is clear why the present invention has distinct advantages over the prior art. The use of ballistic missile or projectile technology, in combination with more traditional transport means, accomplishes the goal of potentially covering thousands of miles within a transport system. Indeed, even re-entry technology may be employed whereby the projectile is fired into near orbital regions for capture far afield upon the surface of the earth. In addition, launch to and from submersible areas is contemplated for maritime operations, and of course, launch reaching escape velocity is possible for transport off of the earth.

According to the invention, the system will utilize a robotics section and a dispensing fixture or apparatus in order to prepare and transport products with utmost safety through the use of projectile technology. In some embodiments, security measures, by way of example and not by way of limitation, such as blockchain and cryptographic technology may be employed. The ecosystem uses both novel concepts, such as the modified transportation shells with ramjet technology that ruggedize the mechanics, modified drone technology for the safe departure and landing of goods, and an allover more streamlined process for facilities that need to deliver goods with more urgency, and therefore bypassing conventional methods that may delay delivery. Concepts that are currently in the marketplace, such as automated processing of goods and services through mobile or electronic devices, are utilized in the mechanics of the system. Robotic devices that have the ability to grip and apportion goods to stations may be utilized in the present invention, through drop and transportation stations that are either on land or in bodies of water.

The carriers or transportation shells may have watertight and airtight properties to assure that contents of these carriers do not escape outside and become uncontrollable. In the event that this happens, as mentioned prior, the indicator will inform handlers and activate a warning, either in the form of a digital output, a locking method wherein only certain individuals are privy to clearing out the carrier. In other words, the carrier remains locked because a potentially hazardous condition exists within the interior of the carrier, and accordingly, the carrier remains locked until suitable preparations may be made for cleaning or clearing out the payload.

When smart carriers are used, a lock may be employed for any reason to secure the payload within the carrier, whereby the carrier remains locked and secures the payload, but, when the intended recipient receives the smart carrier containing the payload of interest, the recipient, under appropriate circumstances, may be able to access the payload. For example, if the payload is actual cash or marketable securities, then the smart carrier will remain locked until only an authorized recipient may utilize or present biometric means to verify the identity and gain access to the payload or value. Through the use of this embodiment, a sender may actually send cash or other marketable securities to a recipient without relying on an electronic wire transfer. In another embodiment, the payload may require payment prior to it being accessed within the smart carrier. That is, the recipient needs to “pay for” the payload, for example, by way of a smartphone, at which point the sender criteria for payment may be met, payment tendered, and then the smart carrier changes to an “unlock” state so the recipient may retrieve the intended payload. In addition, the any carrier may be fitted with GPS and smart tags so that they may be tracked and kept track of, and perhaps a deposit may be received for carriers returned to the system (akin to soft drink bottle deposit returns).

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIGS. 1A-B are diagrams showing the ballistic projectile apparatus of the present invention.

FIG. 2 is a diagram of a self-propelling underwater torpedo transportation shell or carrier of the present invention.

FIG. 3 is a diagram of a transportation shell or carrier of the present invention.

FIG. 4 is a diagram of the ramjet design where the force exerted through the ballistic projectile apparatus of the present invention.

FIG. 5 is a diagram of the projectile delivery system of the present invention.

FIG. 6 is an image of a map view implementation of the present invention.

FIGS. 7A-B are images of map views showing the underwater delivery implementation of the present invention.

FIG. 8 is a diagram of a self-propelling underwater torpedo transportation shell or carrier of the present invention.

FIGS. 9A-C are images of a transportation shell or carrier of the present invention.

FIG. 10 is a diagram showing various distance options of a projectile device of the present invention.

FIG. 11 is an image of a carrier drone of the present invention.

FIG. 12 is an overall view of an encasement or transportation shell or carrier in accordance with the present invention.

FIG. 13 is an illustration of the transportation shell's delivery technology.

FIG. 14 is a block diagram of an exemplary transportation shell or carrier navigation system.

FIG. 15 depicts a diagram of an aerodynamic communication system in accordance with the present invention.

FIG. 16 is a diagram of a transportation shell or carrier interacting with another transportation shell or carrier for delivery.

FIG. 17 is a line diagram illustrating a decentralized network.

FIG. 18 is a line diagram illustrating a distributed network.

FIG. 19 is a diagram of the process of the present invention.

### DETAILED DESCRIPTION OF THE PREFERRED EMBODIMENT

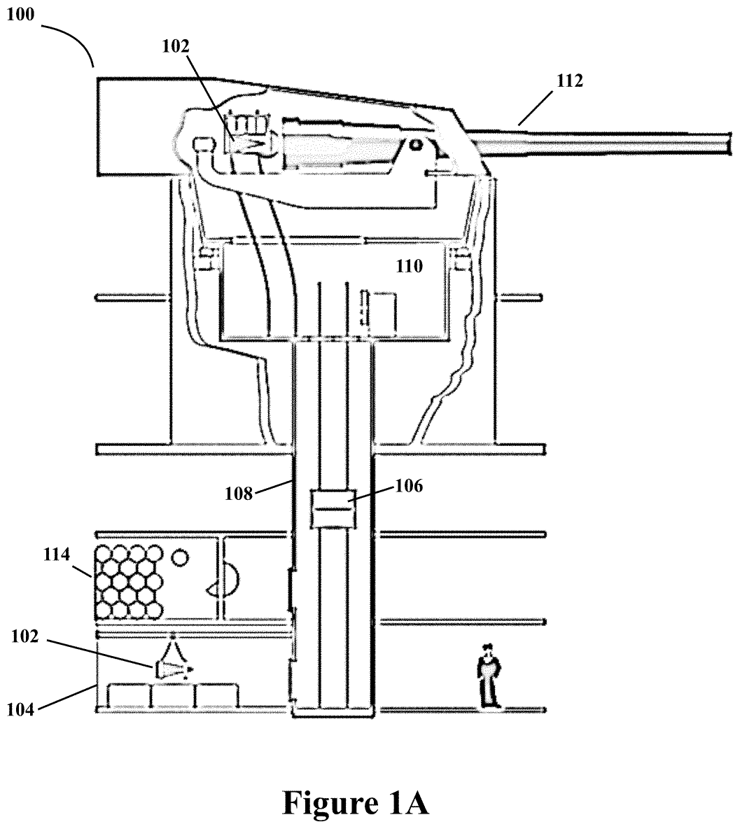

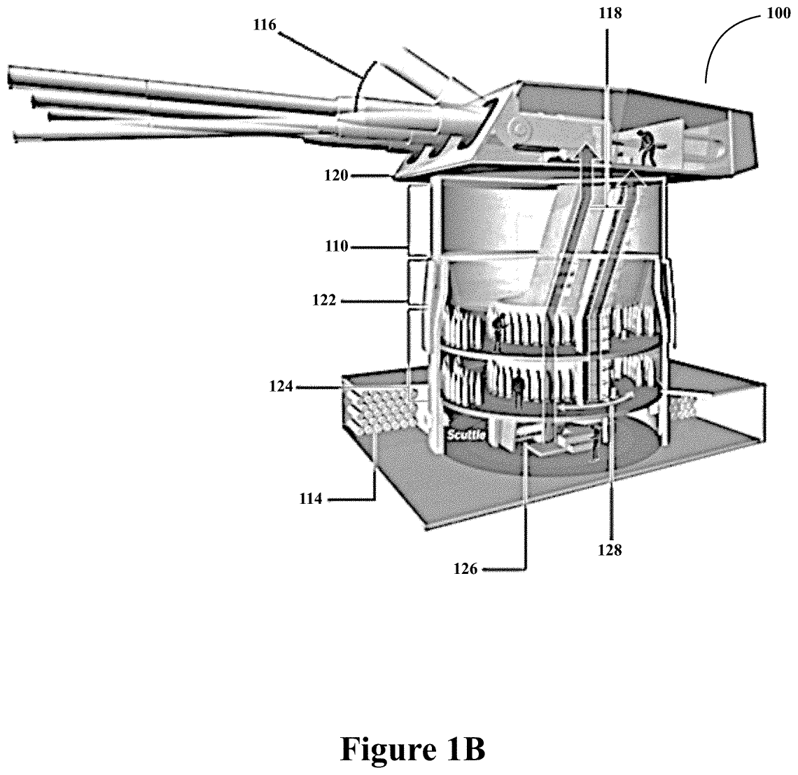

FIG. 1A is a diagram of the ballistic projectile apparatus of the present invention. In accordance with the preferred embodiment of the present invention, a ballistic projectile apparatus 100 can be used as a launch point for the transportation shell or carrier 102 to enable aerial transport. The ballistic projectile may be a missile, and the carrier 102 may be a simple container, or a so-called smart carrier, equipped with electronic surveillance and control means, with GPS sensing and telemetry capability. In the case of a smart carrier, the payload contained within a smart carrier may be monitored as to its temperature from the time of loading a payload into a smart carrier until the moment the payload is unloaded from the smart carrier, and as well, other conditions may be measured, recorded or observed in addition to temperature: humidity, shock or vibration conditions, video imaging, sound recordings, lock and unlock status, open and closed status, the GPS position, etc. At the base 104 of the ballistic projectile apparatus 100, a transportation shell or carrier 102 is loaded on to a carrier elevator 106 for safe transport and conveyed upwards in an elevator shaft 108 to the projectile loading area or pan floor 110, wherein it is loaded into a projectile or mortar 112 by means of a loading interface, where it will be discharged to a landing point. The carrier is automatically situated into a conveyor belt carrier box for safe movement and graduates upwards in order to prepare for the launch through a projectile or mortar, where it will be delivered to either a station or its respective landing point. The contents of the shell are dependent on the goods or payload offered by the distributor. Some distributors may have one item that requires a separate transportation shell or carrier to ensure the safety of the payload contents inside of the carrier or smart carrier, and an additional compartment for items that may require a different environment. For example, an object, such as a specific drug or prescription, may require certain environmental conditions that need a unique type of carrier 102. Other objects with different environmental limitations, as depicted by the transportation shell or carrier casings or magazines 114 which are later compressed, may be packaged safely within the same container with these precautions in mind. The carriers or transportation shells may have watertight and airtight properties to assure that contents of these carriers do not escape outside and become uncontrollable. In the event that this happens, as mentioned prior, the indicator will inform handlers and activate a warning, either in the form of a digital output, a locking method wherein only certain individuals are privy to clearing out the carrier. In other words, the carrier remains locked because a potentially hazardous condition exists within the interior of the carrier, and accordingly, the carrier remains locked until suitable preparations may be made for cleaning or clearing out the payload. When smart carriers are used, a lock may be employed for any reason to secure the payload within the carrier, whereby the carrier remains locked and secures the payload, but, when the intended recipient receives the smart carrier containing the payload of interest, the recipient, under appropriate circumstances, may be able to access the payload. For example, if the payload is actual cash or marketable securities, then the smart carrier will remain locked until only an authorized recipient may utilize or present biometric means to verify the identity and gain access to the payload or value. Through the use of this embodiment, a sender may actually send cash or other marketable securities to a recipient without relying on an electronic wire transfer. In another embodiment, the payload may require payment prior to it being accessed within the smart carrier. That is, the recipient needs to “pay for” the payload, for example, by way of a smartphone, at which point the sender criteria for payment may be met, payment tendered, and then the smart carrier changes to an “unlock” state so the recipient may retrieve the intended payload. In addition, the any carrier may be fitted with GPS and smart tags so that they may be tracked and kept track of, and perhaps a deposit may be received for carriers returned to the system (akin to soft drink bottle deposit returns).

FIG. 1B shows a more detailed view of the ballistic projectile apparatus architecture of the present invention. In accordance with the preferred embodiment, the ballistic projectile apparatus station 100 consists of a set of guns in a turret 116 that can fire and move independently from a 45-degree elevation to a 5-degree depression. The barrel length may be 68 feet. Powder bags and projectiles are lifted to the projectile loading interface by hoists 118. The loading interface 120 has turret control and projectile discharging interface controls, wherein crews can operate the projectile through the loading interface and discharging interface. The pan floor 110 has pits into which the ballistic projectile discharge apparatus is depressed as barrels are elevated, and also may include ballistic projectile apparatus loading and discharging machinery. The machinery floor 122 has operating stations for elevating the ballistic projectile apparatus and rotating the turret, as well as other machinery for the operation of the band interface and discharge interface. The projectile storage 124 can consist of two levels, one of which is a room to store projectiles of various types depending on what is needed for the ballistic projectile apparatus or turret, stored on ends in concentric circles. The magazines 114 are held in powder bag storage, wherein several bags may be required to fire the projectile apparatus. The powder-handling room 126 contains powder bags passed in from the magazine 114 through flat-proof scuttles and loaded on to a hoist. The inner rings of the projectile floors rotate 128 to facilitate movement and loading. The system will auto load the transport container into the shells, and the transportation shells may also auto load into the projectile apparatus.

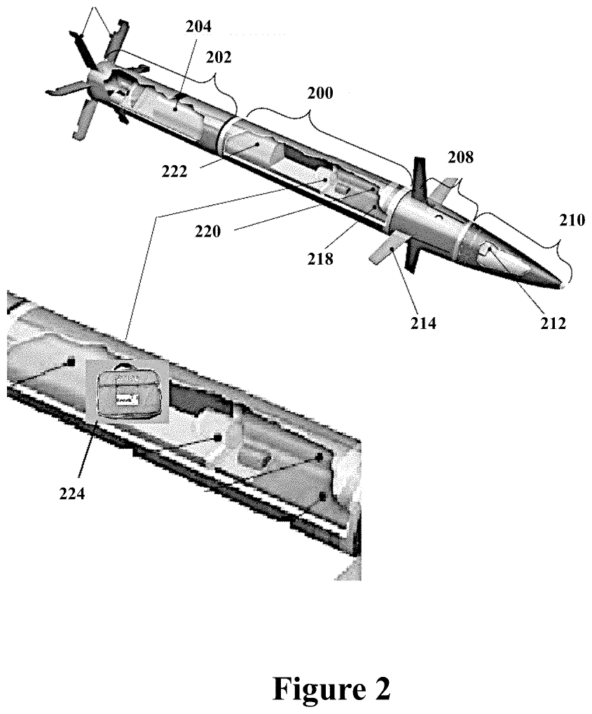

FIG. 2 is a diagram of a self-propelling underwater torpedo transportation shell or carrier of the present invention. In one embodiment, an underwater torpedo type transportation shell or carrier can be used for the delivery of the goods or payload 224. The torpedo has 6 cavity-piercing tail fins 206, attached to a rocket motor 202 that advance at exceptional speeds from the rocket motor propellant 204. Stationed above the motor is the novel transportation compartment 200, which may be used to contain vaccines and other goods 224, by way of example and not by way of limitation. Above the compartment is space for the flight battery 220, and telemetry system 218 which uses a modulator, voltage-controlled oscillator, and a power supply to transmit data. Above the telemetry system is a Canard Actuation System (CAS) 208 which acts as a position controller for its surface, featuring 4 canards 214. Above that, at the narrow extremity of the missile, is the Guidance Electronics Unit (GEU) 210 which have Height-of-Burst (HOB) 212 sensors for the guided missile.

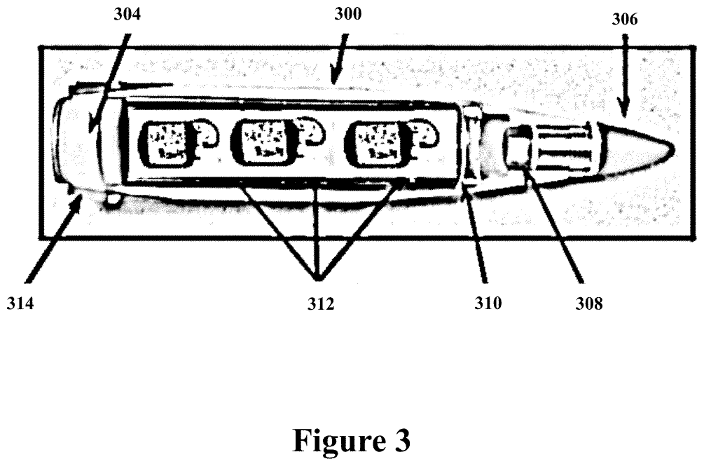

FIG. 3 is a diagram of a transportation shell or carrier of the present invention. In accordance with the preferred embodiment, the transportation shell or carrier features a base plug 304, a discarding rotating band (DRB) 314, and a transportation compartment 300 which may be used for transporting items such as blood bags, vaccines, and other goods or payload 312. During a launch, the force from the pusher plate 308, 310 which is located below the transportation shell's electronic time sensor 306 spreads. The electronic time sensor, which rests at the shell's extremity, is used to convert light and shifts in light into electronic signals which trigger predefined responses. The carrier may be a regular carrier that contains a payload, or a smart carrier as explained herein.

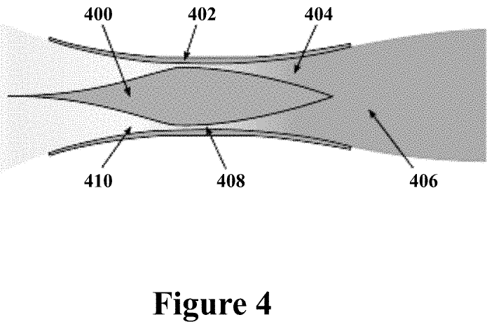

FIG. 4 is a diagram of the ramjet design where the force exerted through the ballistic projectile apparatus of the present invention. In accordance with the preferred embodiment, air goes through the air intake model 402, and becomes compressed 410. The figure depicts an inlet body 400, an area for fuel injection 402, a nozzle 404, and the process of supersonic compression 410, combustion 408 and its supersonic exhaust 406.

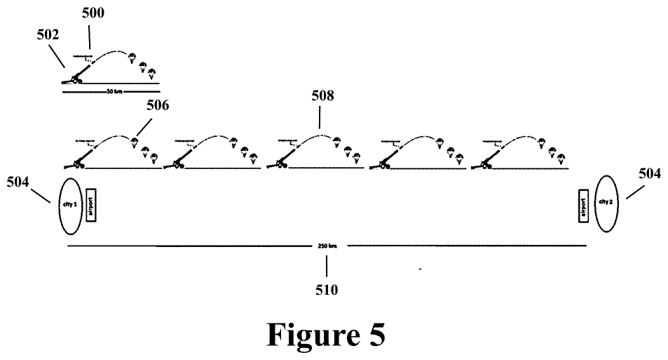

FIG. 5 is a diagram of the projectile delivery system of the present invention. In one embodiment, the delivery of goods can utilize a ballistic projectile apparatus 502 such as a missile projectile or a classic howitzer 502. This ballistic projectile apparatus may be stationed between cities and airports 504 and may have a launch range of 50 kilometers per station 508, which allows for the transportation shell or carrier 506 to move up to 250 kilometers 510 depending on the number of stations 500 between each destination. Goods or payload may be transported in a secure transportation shell or carrier 506 to each individual projectile station 500 in order to reach the final target destination 504.

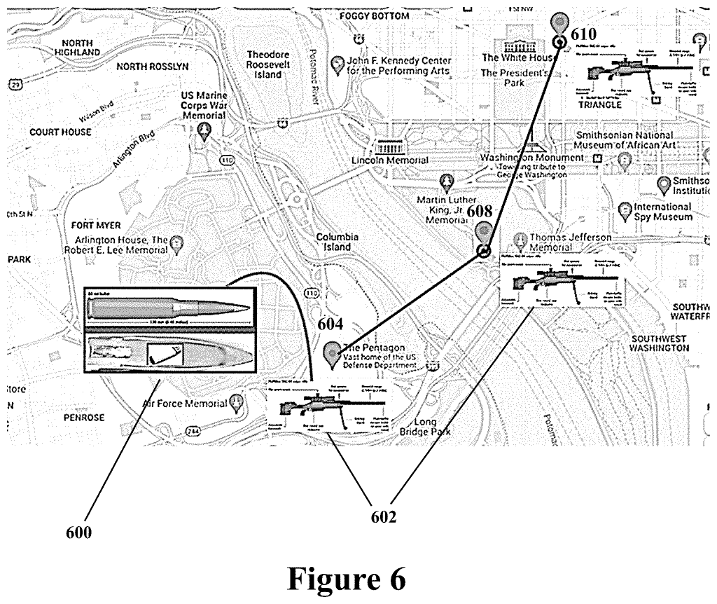

FIG. 6 is an image of a map view implementation of the present invention. In one embodiment, the ballistic projectile apparatus 600 used to propel the transportation shell or carrier may be a cannon or a rifle 602. In an attempt to illustrate the way sniper rifles 602 may be utilized in these systems and methods, FIG. 6 showcases a map view wherein rifles, which are stationed at three different pinpoints 604, 608, 610, that each expand across 3 miles. The rifles house .50 caliber bullets 600 that are 138 mm and 5.45 inches in length, and their modified shell can store data and information in order to exchange highly secure messages 600 or payloads. This may be done with flash drives, or cryptographic measures that maintain privacy. Secure messages are delivered through each pinpoint with the use of sniper rifles that discharge modified bullets through varying points 604, 608, 610.

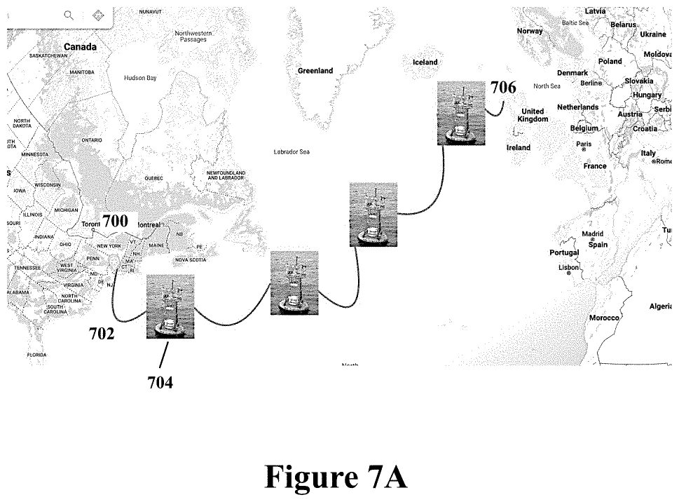

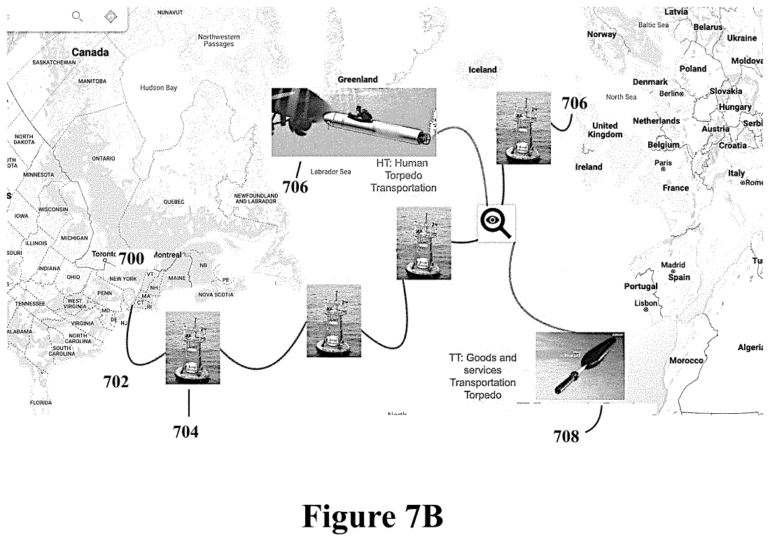

FIGS. 7A-B are images of map views showing the underwater delivery implementation of the present invention. FIG. 7A illustrates the torpedo method in greater detail, via a map view of ocean stations across the sea, first in a US destination 700, and then to a UK destination 706. In FIG. 7A, the torpedo method for underwater or subsea delivery implementation is seen through a map view of ocean stations 704, also pictured in FIG. 7B, with the additional human torpedo transportation unit 706 and goods transportation units 708. FIG. 7B is another illustration of the torpedo method, but with a broader view of human torpedo transportation and goods transportation torpedoes 702 across the United States and Europe.

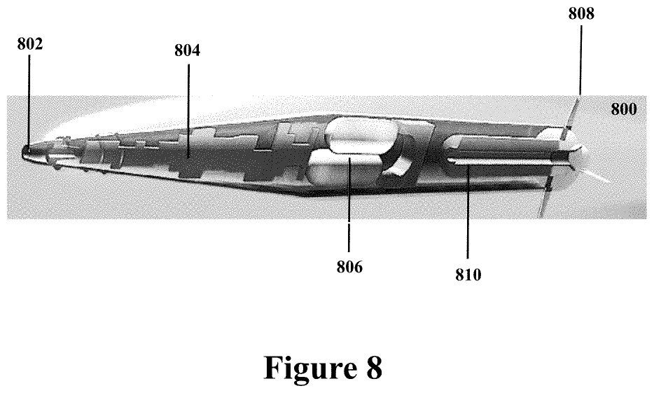

FIG. 8 is a diagram of a self-propelling underwater torpedo transportation shell or carrier of the present invention 800. In one embodiment, a torpedo missile transportation shell or carrier 800 for underwater transportation and delivery is depicted. The torpedo transportation shell or carrier as shown features a cavitator 802, which generates propulsion of the transportation shell or carrier through the sudden formation and collapse of low-pressure bubbles in liquids by means of mechanical forces, such as those resulting from rotation of a propeller. The cavitator 802 ejects gas through the torpedo's nose and utilizes detection and homing electronics 804 to ensure the torpedo remains on target. The torpedo transportation shell or carrier also features storage tanks 806 for the bubble generating gas, as well as an exceptionally high-speed rocket motor 810 that has an acceleration rate of 230 miles per hour. On the opposite end of the torpedo are control fins 808 that drive or steer the torpedo missile transportation shell.

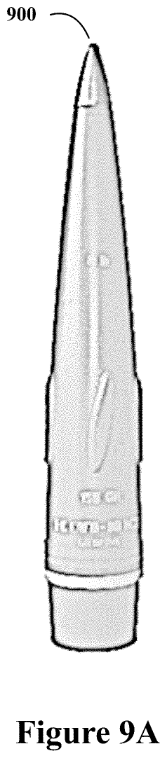

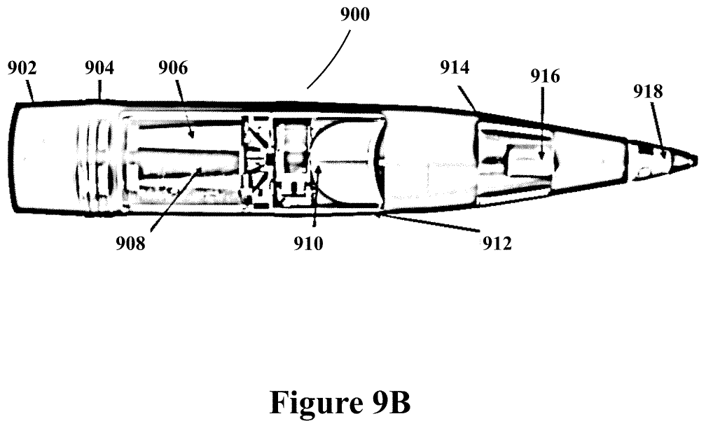

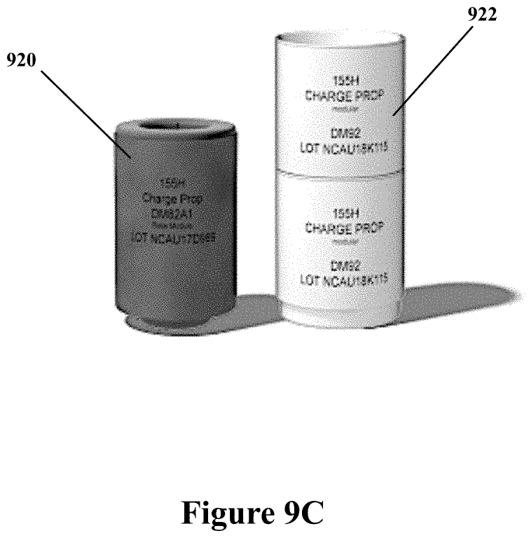

FIGS. 9A-C are images of a transportation shell or carrier of the present invention. As shown in FIG. 9A, a transportation shell or carrier 900 may resemble that of a typical 155 mm long range artillery projectile shell that can be inserted into any modern towed and self-propelled 155 mm weapon to project, transport and deliver the goods or payload. This type of transportation shell or carrier may be inertial-guided and may incorporate GPS guidance for improved accuracy. This type of transportation shell or carrier has a range of approximately 40 to 57 kilometers (25 to 35 mi) depending on configuration, with a circular error probable (CEP) measuring a precision of approximately 4 m. the extended range may also allow the projectile to glide from the top of a projectile arc towards the target destination or subsequent projectile station. This type of transportation shell or carrier 900 may also incorporate smart projectile elements for moving and time-sensitive targets, and discriminating projectile elements to search, detect, and selectively engage in target destinations by distinguishing specific target characteristics.

FIG. 9B shows the components that make up a transportation shell or carrier 900, for example a 155 mm bonus projectile, including the base with the live base-bleed 902, the drive band 904, the aft cylinder 906 and aft submunition 908 inside of the cylinder, the forward submunition 910, the thin-walled carrier shell 912, the ogive 914, the ejection charge 916, and the time fuse and sensor 918. FIG. 9C shows two charge props 920, 922, and each may be pushed behind the round of the transportation shell or carrier to propel it into the air from the projectile apparatus. The shells 900 are reusable. And the containers inside the shells are also reusable. The shells convert into drones in flight. Inside the shells is the container which encloses the product to transport.

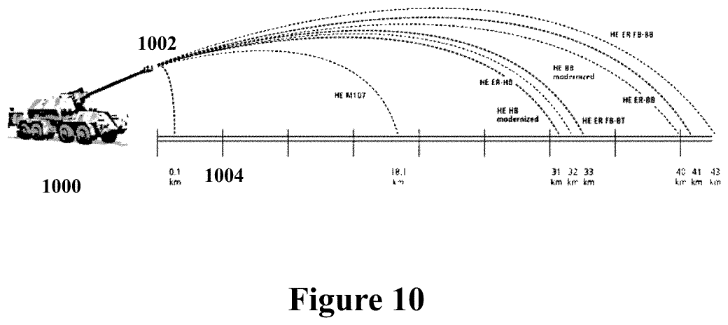

FIG. 10 is a diagram showing various distance options of a projectile device 1000 of the present invention. As shown in FIG. 10 is a model of the ranges 1004, in kilometers, of the transportation shells discharged from the howitzer, or similar projectile device 1000, which can be used as a ballistic projectile apparatus for transportation shells 1002. The projectile or mortar 1000 can be angled depending on the distance 1004 required for the transportation shell or carrier 1002.

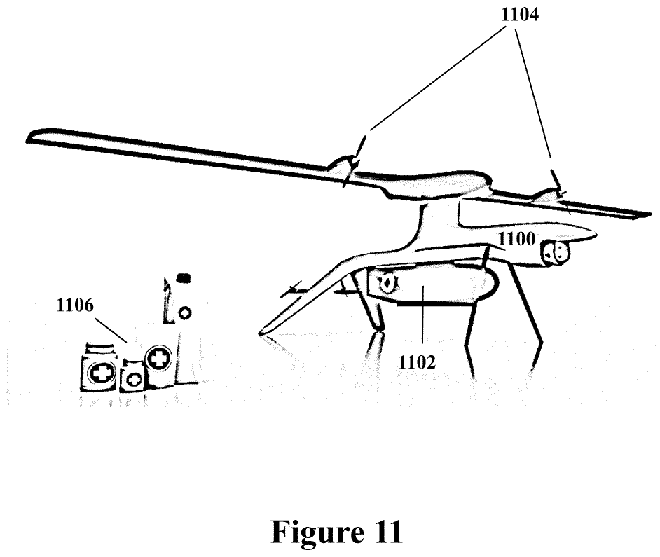

FIG. 11 is an image of a smart carrier drone of the present invention. In one embodiment, a drone may be used in combination with a transportation shell or carrier for the delivery of goods. The drone, as shown in FIG. 11, is an illustration of the smart carrier 1102 fixed on to a drone 1100 for transporting the goods or payload 1106. The drone, with modified rotors 1104 to ensure the device can withstand more in terms of weight, and distance. These modified rotors 1104, which feature a propeller attached to a motor that push the air down, hover as the thrust of the drone is equal to the gravitational pull that works against it. As shown in FIG. 11, the drone enabled 1100 transportation shell or carrier 1102 optimizes both hovering and forward flight by utilizing articulating and rotating wing design, and using the whole wing as a highly efficient rotor that does not compromise forward flight performance characteristics when transitioned to fixed wing mode. the drone enabled 1100 transportation shell or carrier 1102 can connect midflight. Once the carrier 1102 has been discharged from the launch point, it can connect with the drone 1100 for additional transport of the payload 1106 to the landing point.

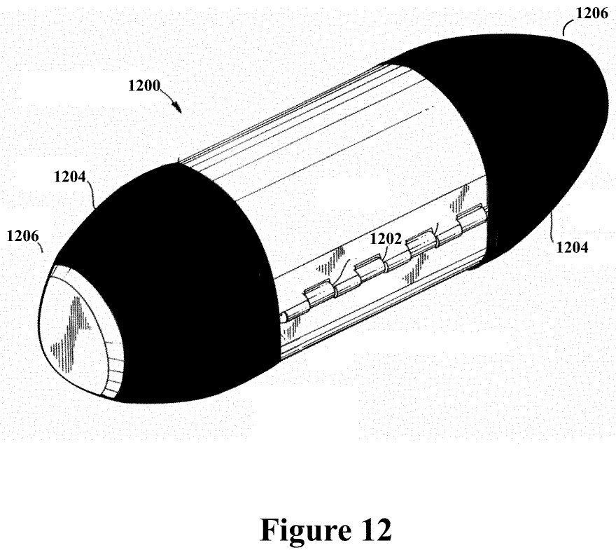

FIG. 12 is an overall view of an encasement or transportation shell or carrier in accordance with the present invention. Obviously, the carrier may be a regular carrier sufficient to carry a payload, or a smart carrier for locking and securing (and monitoring) a payload. Electronic locks may be employed upon any carrier, regular and smart. In addition, a payload may be directly placed within a transportation shell or encasement (or other accessible cavity), so that the use of a dedicated carrier or smart carrier may be obviated. In that case, the transportation shell may be lockable as desired. FIG. 12 shows an encasement 1200 consisting of an exterior shell extending longitudinally and interconnected by hinges and locking mechanisms 1202, which securely lock the shell, so that hinges 1202 can provide for the opening and closing of the exterior shell 1200. Each end of the exterior shell is covered by a thin layer of a rubber or rubber-like material 1204 to provide additional encasement protection and to allow for secure placement in a loading and transportation apparatus. The purpose of the exterior shell coverings 1204 is so that shell 1200 forms a tight, consistent and secure fit within the interior of the projectile cannon, so that the shell 1200 may be loaded effectively into the projectile cannon. In order to simplify this description, parts of the encasement or transportation shell or carrier 1200 will be described, but it should be understood that corresponding parts of shell 1200 also may exist, as desired. The shell 1200 is generally semi-cylindrical over the major portion of its length, which may contribute to the overall structural integrity of the encasement. The shell 1200 further includes tapered aerodynamic end portions 1206. Hinge assemblies 1202 are preferably molded as a part of the shells 1200 and are offset from edges of the shell 1200 to permit the shell 1200 to securely seal when closed. Hinges 1202 are preferably located so that they will not contact the interior of a projectile cannon.

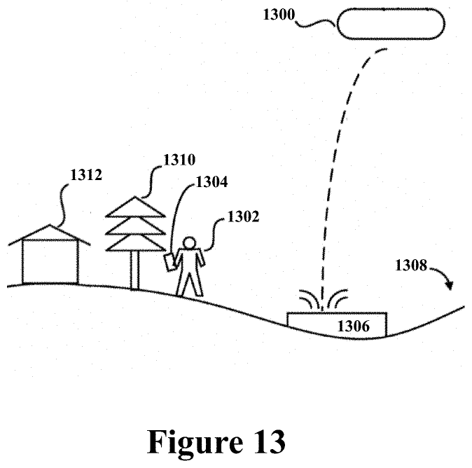

FIG. 13 is an illustration of the transportation shell's delivery technology. In one embodiment, a transportation shell or carrier 1300 is in route to a customer 1302 that has placed an order. The customer 1302 may specify a delivery location which will vary dependent on the customer's uses and needs. When a customer 1302 places an order or request for delivery of a payload, or at some time thereafter, the customer 1302 goes to a location or landing point where they 1302 would like to receive their delivery 1300. The customer 1302 then uses a mobile device with access to an electronic network 1304 with a Global Positioning System (GPS) application (app) to receive the GPS coordinates of their target landing point. Alternatively, the customer 1302 can utilize Internet mapping services to obtain the GPS coordinates of the desired landing point. The customer 1302 may choose to upload the GPS coordinates to the merchant or organization's network, and subsequently become a part of the delivery, wherein they have the option to provide a preferred date and time for delivery. In the example showcased in FIG. 13, the payload delivery landing point may be any desired location, for example, a specified landmark or designated area 1306 or an open environment 1308, so that the transportation shell or carrier and payload transported therein 1300, when delivered, do not encounter or are damaged by environmental elements 1310 or residences 1312. The transportation shell or carrier 1300 may allow for GPS tracking and coordination to ensure a safe delivery to the landing point.

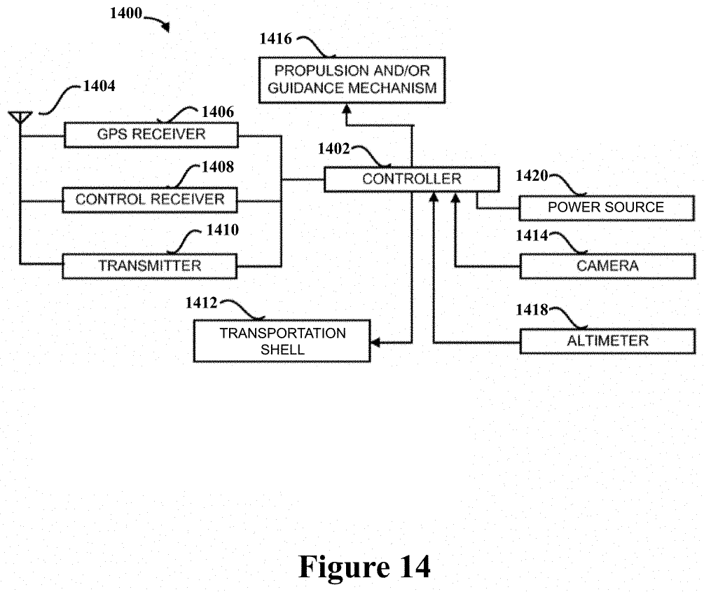

FIG. 14 is a block diagram of an exemplary transportation shell or carrier navigation system. The navigation system 1400 has a controller 1402, one or more antennae 1404, a GPS receiver 1406, a control receiver 1408, a transmitter 1410, the transportation shell or carrier 1412, an optional camera 1414, a propulsion mechanism 1416, an altimeter 1418, and a power source 1420. There may be a solitary antenna 1404 shared by the receivers 1406 and 1408 and transmitter 1410, featuring two or more antennae. The control receiver 1408 may be used to receive the GPS coordinates of the established delivery location and other information and commands that are to be provided to the controller 1402. The transportation shell or carrier 1412 may also utilize a variety of payload securing elements, with the ability to be individually controlled and designated to different delivery regions. An optional camera 1414 may display a view of the landing point, or an aerial view. In another embodiment, the camera 1414 provides an image of the landing point, and the controller 1402 allows that picture to be transmitted 1410.

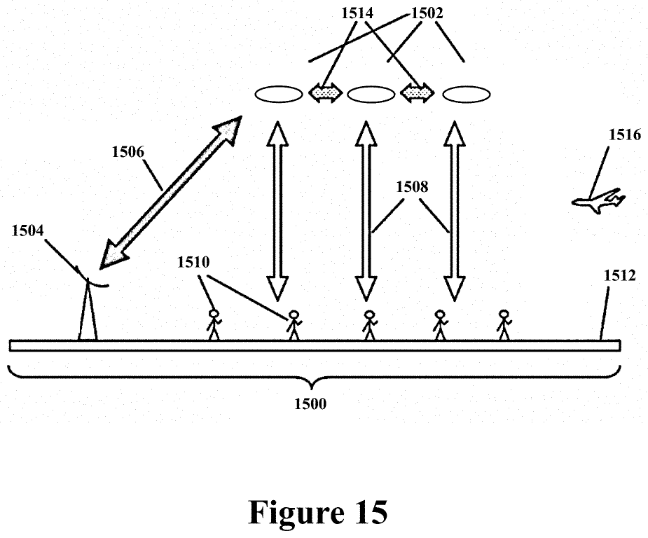

FIG. 15 depicts a diagram of an aerodynamic communication system in accordance with the present invention. In one embodiment, airborne systems are provided for allowing wireless communication 1508 for end users both on the ground and in the air. Transportation shells 1502 are discharged from a ballistic projectile apparatus located on the ground 1504 and travel aerially 1506 in order to execute deliveries. A communication system 1500 is to be implemented for mobile radio transceivers. These transceivers may be mobile devices and applications that are located on the ground or potentially in aircrafts or drones 1516 in certain operations. In some examples, transportation shells 1502 with the implemented communication system capabilities may elect to eject deliveries should a set of predefined rules become triggered. Transceivers may be mobile devices operated by individuals 1510 on the ground 1512. Distances 1514 between the transportation shell or carrier 1502 and other objects vary and are dependent on the communication capabilities and requirements of the provided communication service. Communication services that are provided by the communication system 1500 may be continuous e.g., 24 hours a day and 7 days a week, year-round, etc. or temporary in nature, e.g., one or more hours of the day, for emergency or daytime support only, or hours that are in peak demand.

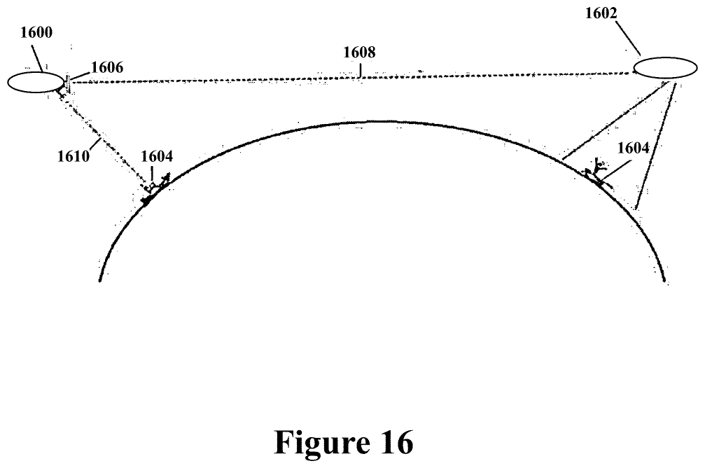

FIG. 16 is a diagram of a transportation shell or carrier (or smart carrier) interacting with another transportation shell or carrier for delivery. In one embodiment, a transportation shell or carrier 1600 may interact with other transportation shells 1602 and a base projectile station 1604. The transportation shell or carrier 1600 may be controlled by the base projectile station or configured to remain within the base projectile station's 1604 line of sight. Alternatively, the drone may also be operated remotely, with some settings available for the customer to view and control. The transportation shell or carrier 1600 may have a mode in which the transportation shell or carrier 1600 has the ability to monitor and surveil the location of the base projectile station 1604 and circulate the base projectile station from either above or behind the base projectile station 1604 as it moves. The base projectile station 1604 has the ability to transmit GPS data, such as location signals or other signals, to other transportation shells 1600. These transportation shells 1600 also have the ability to utilize different functions and modes, such as one mode to autonomously sense the locality of the base station 1604 and another that prevents the base station from actively broadcasting its location. A transportation shell or carrier 1600 may rely upon sensors to locate the base projectile station 1604 through either image edge detection, or other unique and trackable characteristics of the transportation shell. The transportation shell or carrier 1600 may have functions to monitor the transportation shell's activity, relay information to users regarding their deliveries, and communicate signals between base projectile stations 1604. Technology allowing the ability to control aspects such as flight and navigation patterns, communication protocols, and instrumentation use, may be embedded 1606 within the transportation shell or carrier 1600. Of course, security concerns will vary depending upon the needs of senders and recipients, and according to the present invention the payload security requirements may be factored into account. For example, if a payload is cash or very valuable, then the transport path of the ballistic projectile may be selected to avoid flight over a territory deemed to be at high risk for third party unauthorized interception. In addition, according to the present invention, the payload may even be toxic or hazardous materials or manufacturing biproducts, so that according to the present invention, an efficient and safe disposal system is provided. Also, if a sender needs to expedite delivery to a particular recipient, then increased costs may be factored in, so that cost, safety and delivery times, based on the character, nature and value of the payload and its stability over time, may all be factored in. Indeed, a carrier or smart carrier may also include payload stability devices to control payload temperatures and other environmental conditions. This embedded technology 1606 establishes communication links between transportation shells 1608, or between the transportation shell or carrier and the base projectile station 1610 and may consist of any type of communication protocol from which devices can communicate, such as Wi-Fi, Bluetooth, RFID, broadcast radio, satellite communications, and other combinations of infrared (IR) wireless communication. In the embodiment according to the present invention, a payload may be placed within a transportation shell or carrier or smart carrier, lockable so that the title to the payload may actually be passed along from a sender to an intended recipient, and any attempt by the intended recipient to confiscate the payload without paying for it may result in countermeasures, such as destruction of the payload or an alarm and surveillance process by which the potential theft is thwarted in one way or another. Such an arrangement may be used to transfer actual cash, so that a part seeking to misappropriate such a delivery is deterred from the attempt in the first place, aware that countermeasures have been activated.

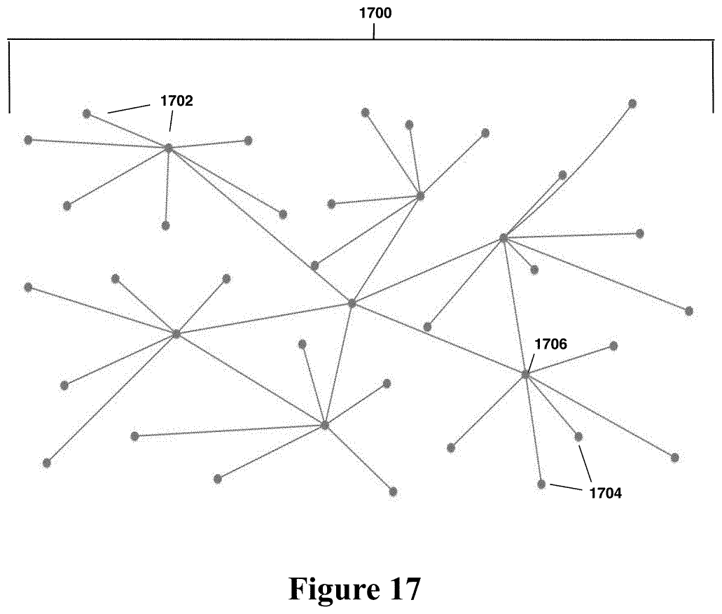

FIG. 17 is a line diagram illustrating a decentralized network. In accordance with the preferred embodiment of the present invention, the specific architecture of the network can be either decentralized or distributed. FIG. 17, generally represented by the numeral 1700, provides an illustrative diagram of the decentralized network. FIG. 17 depicts each node with a dot 1702 Under this system, each node is connected to at least one other node 1704. Only some nodes are connected to more than one node 1706.

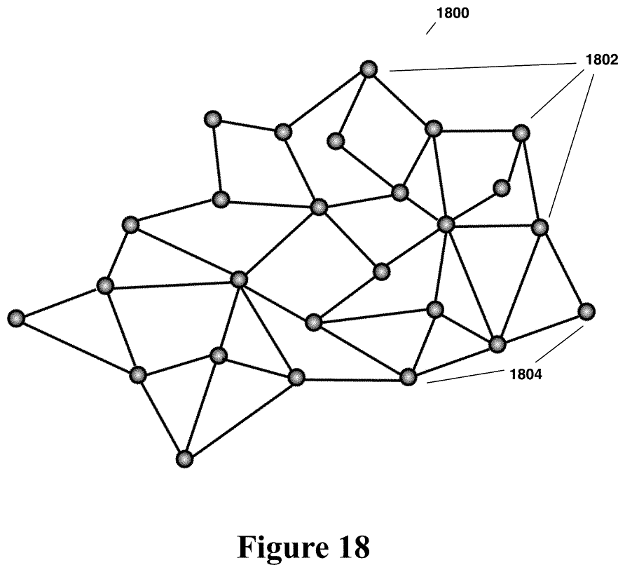

FIG. 18 is a line diagram illustrating a distributed network. For comparison purposes, FIG. 18, which is generally represented by the numeral 1800, illustrates a distributed network. Specifically, the illustration shows the interconnection of each node 1802 in a distributed decentralized network 1800. In accordance with the preferred embodiment of the present invention, each node 1802 in the distributed network 1800 is directly connected to at least two other nodes 1804. This allows each node 1802 to transact with at least one other node 1802 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

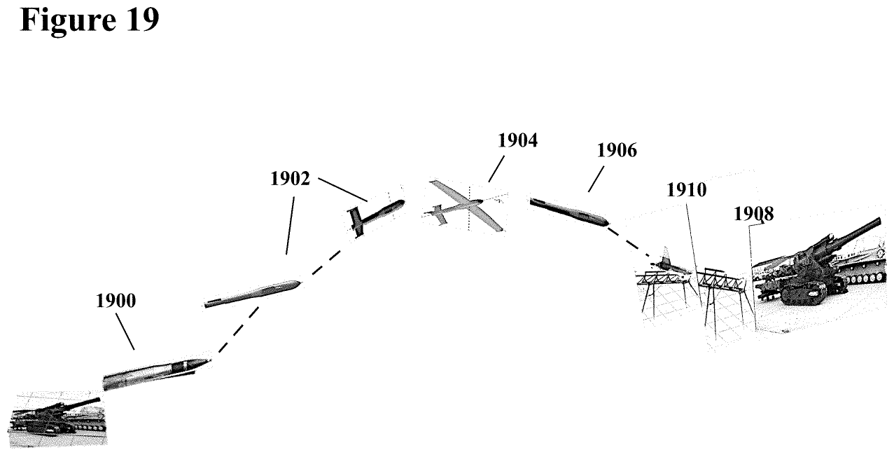

FIG. 19 is a diagram of the process of the present invention. In accordance with the preferred embodiment, the artillery shell carrier is fired 1900 through a ballistic projectile apparatus, and the shell extends rudders and stabilizers 1902, or wings 1904. Then in preparation to land on a rail 1908, the shell retracts wings 1906, keeping the rudders and stabilizers 1906. The carrier lands on the rail or landing point and is connected to the artillery compartment or loading interface and discharging interface 1910. The payload inside the carrier ejects into the next artillery shell compartment 1908.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for transporting a payload from a sender to a receiver, wherein said payload is introduced into an interior of a ballistic projectile, and wherein said ballistic projectile is projected from a launch point to a landing point, and wherein said payload is loaded into said ballistic projectile by a loading interface and wherein said payload is removed from said ballistic projectile by way of a discharge interface, and wherein said loading interface accepts and positions said payload within said ballistic projectile and wherein said discharging interface enables a recipient to offload said payload from said ballistic projectile.

2. A system according to claim 1 wherein said loading interface enables a drone to offload a payload into said ballistic projectile.

3. A system according to claim 1 wherein said discharge interface enables a drone to receive a payload offloaded from said ballistic projectile.

4. A system according to claim 1 wherein said payload is encapsulated by a carrier and said carrier is loaded into said ballistic projectile by way of said loading interface.

5. A system according to claim 4 wherein said carrier includes sensors to determine conditions associated with said payload within said carrier.

6. A method for transporting a payload from a sender to a receiver, wherein said payload is introduced into an interior of a ballistic projectile, and wherein said ballistic projectile is projected from a launch point to a landing point, and wherein said payload is loaded into said ballistic projectile by a loading interface and wherein said payload is removed from said ballistic projectile by way of a discharge interface, and wherein said loading interface accepts and positions said payload within said ballistic projectile and wherein said discharging interface enables a recipient to offload said payload from said ballistic projectile.

7. A method according to claim 6 wherein said loading interface enables a drone to offload a payload into said ballistic projectile.

8. A method according to claim 6 wherein said discharge interface enables a drone to receive a payload offloaded from said ballistic projectile.

9. A method according to claim 6 wherein said payload is encapsulated by a carrier and said carrier is loaded into said ballistic projectile by way of said loading interface.

10. A method according to claim 9 wherein said carrier includes sensors to determine conditions associated with said payload within said carrier.

11. A method according to claim 6 wherein said payload is cash.

12. A ballistic transport mechanism for transporting payloads from a point of origin to a destination point, said mechanism including an artillery projectile for containing said payloads, so that said payloads may be safely transported between said point of origin and said destination point in a manner to maintain the structural integrity and quality of said payload, and wherein said artillery projectile may be opened to enable insertion of and removal of said payload from said artillery projectile, and said artillery projectile may be closed for safe transport of said payload from said pint of origin to said destination point, and wherein said artillery projectile may be either opened or closed for non-use when stored.

13. A mechanism according to claim 12 wherein said artillery projectile is accessible to enable a drone to offload said payload into said artillery projectile.

14. A mechanism according to claim 12 wherein said artillery projectile is accessible to enable a drone to receive a payload offloaded from said artillery projectile.

15. A mechanism according to claim 12 wherein said payload is encapsulated by a carrier and said carrier is loaded into said artillery projectile by way of a loading interface.

16. A mechanism according to claim 13 wherein said carrier includes sensors to determine conditions associated with said payload within said carrier.

17. A mechanism according to claim 12 wherein countermeasures are employed by said carrier to deter theft of said payload.

18. A mechanism according to claim 12 wherein said payload is cash.
